(19) United States
(12) Patent Application Publication
(10) Pub. No.: US 2003/0020765 A1
(43) Pub. Date: Jan. 30, 2003

(54) Method and system for transforming limited source graphical data

(76) Inventors: Clifton L. Kussmaul, Bethlehem, PA (US); Robert E. Smith, South Riding, VA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 10/143,886

(22) Filed: May 14, 2002

Related U.S. Application Data
(60) Provisional application No. 60/290,619, filed on May 14, 2001.

(51) Int. Cl. G09G 5/00

(52) U.S. Cl. 345/853

(57) ABSTRACT

A system, method and computer program product for transforming limited graphical source data to coherent transformed data. In one embodiment, the coherent transformed data is a hierarchical data structure. The hierarchical data structure represents elements and relationships between the elements. The present invention identifies important elements from the objects present in the limited source graphical data, identifies relationships between the identified important elements, and builds the hierarchical data structure to represent the identified important elements and identified relationships between the important elements. In one embodiment, the present invention includes a map crawler tool. The map crawler tool has a user interface and a transformation engine.

### CROSS-REFERENCE TO RELATED APPLICATIONS

This application claims the benefit of priority to the provisional application by Kussmaul et al., “Process for Obtaining Hierarchical Data Structures from Vector Graphic Data,” U.S. Appl. No. 60/290,619, filed on May 14, 2001 and incorporated by reference herein in its entirety.

### BACKGROUND OF THE INVENTION

1. Field of the Invention

The present invention relates to data processing.

2. Related Art

Many software programs and data file formats represent and manipulate graphical data. Popular software programs include AutoCAD and Adobe Illustrator. Popular file formats include AutoCAD Drawing (DWG), Drawing Interchange Format (DXF), and Postscript (PS).

These programs and file formats usually share a number of characteristics:

They were designed to display and/or print graphical information.

They represent graphical data as a set of objects.

Objects may be primitives, such as lines, polygons, arcs, and circles, with appropriate attributes. For example, a line can be described by its start and end points, and a circle can be described by a center point and radius.

Objects may also be blocks, which are user-defined sets of primitives that can be used many times in one or more files.

Objects may be grouped into layers. For example, a city map might have separate layers for streets, houses, commercial buildings, and area names.

Objects may also include auxiliary information, depending on the program, file format, and the particular application.

For example, many broadband service providers use AutoCAD data files to describe the relative positions of buildings, telephone poles, wires, optical fibers, amplifiers, splitters, taps, and other hardware used to relay signals between central facilities and individual subscribers. In some cases, these data files may also contain street names, the street address for each building, and configuration information for cable system hardware.

There is growing interest in using this data in other ways, and particularly in obtaining hierarchical structures and then integrating the results with other, non-graphical information. For example, broadband companies are investigating ways to utilize this data to automatically monitor network activity, diagnose problems, and dispatch staff and equipment to make repairs.

The software programs and data file formats for graphical data typically share a number of shortcomings in this regard:

1. They contain little non-graphical information about objects.

2. They do not contain connections between objects.

FIG. 1 is a diagram that illustrates an example of incomplete source graphical data displayed as maps. Two maps 100 and 150 are shown. Each map 100, 150 shows elements which are visually perceptible to a user when printed out or displayed. For example, map 100 includes a cable link 110 running along a street 140. A house 120 is shown near street 140 and a section of link 110. Taps 105, 115 are provided along link 110. Textual information called a tombstone 125 is also displayed near house 120 and street 140. Map 150 shows other elements at a different section of the cable network. Map 150 includes a section of street 140 and another section of link 110. A tap 160 is provided along link 110 and is positioned on pole 170.

The information in maps 100 and 150 is generally prepared according to local design customs, practices and rules. A user of the map, such as a cable technician, prints or displays maps 100, 150 to obtain information on the portions of the cable network. Because the maps were designed for visual perception underlying graphical data is incomplete for many other applications. For example, relationships between elements in the maps may be incomplete or unclear. In map 100 it is unclear whether house 120 is associated with tap 115 or tap 105. Similarly, it is unclear if house 120 is associated with text 125. Objects in the graphical data of the map file corresponding to map 100 may include primitives which define taps 105, 115 and house 120. These objects may also include blocks or layer information.

Because the map file was originally prepared for visual perception, however, no connections may have been made between house 120 and tap 115 or the appropriate tombstone 125 since the map designer intended for a user to print the map. An experienced cable technician observing such a printout would then be able to infer or interpret the visual display of map 100 and make appropriate connections between elements. For example, an experienced cable technician could infer that tap 115 is associated with house 120 on street 140. The experienced cable technician could also infer that the text in tombstone 125 is associated with house 120 based on the proximity of the elements within map 100 and the appropriate text information in tombstone 125.

Other problems which can arise are: the use of different coordinate spaces for preparing maps within a cable network, the stretching or warping of positions and distances within a map, and discontinuities at borders or discontinuities in the connections between maps. For example, as shown in FIG. 1, map 150 may have a coordinate space described in terms of global latitude/longitude coordinates while map 100 has a different coordinate space defined relative to map 100 only. Discontinuities can exist at the borders between maps 100 and 150 as shown by the misaligned end points 130 and 190 of link 110 and the misaligned street 140. A “rats' nest” problem can also occur when groups of nearby items are provided without explicit connections. For example, taps 105, 115 and house 120 are all disposed in proximity to each other, but an explicit connection or line is not provided between the elements.

What is needed is a tool that can transform such incomplete graphical data. Connections need to be made between elements in a cable network within a map and between maps. Associations need to be made between appropriate elements in a cable network. Non-graphical information, such as text or other identifying information, needs to be associated with appropriate elements. Further, incomplete graphical data found in map files needs to be transformed such that it can be exported, made available, or analyzed by users and data managers.

### SUMMARY OF THE INVENTION

The present invention overcomes each of the above-identified problems and has additional advantages as described herein.

The present invention provides a system, method and computer program product for transforming limited graphical source data to coherent transformed data. In one embodiment, the coherent transformed data is a hierarchical data structure. The hierarchical data structure represents elements and relationships between the elements. For example, each map file has limited source graphical data made up of objects that define elements. The present invention identifies important elements from the objects present in the limited source graphical data, identifies relationships between the identified important elements, and builds the hierarchical data structure to represent the identified important elements and identified relationships between the important elements.

In one embodiment, the present invention includes a map crawler tool.

The map crawler tool has a user interface and a transformation engine. The user interface receives an input from the user and controls at least part of the operation of the transformation engine in response to the input. The transformation engine transforms limited source graphical data from a plurality of map files to a hierarchical data structure. In one application, the map files represent limited source graphical data that define elements of a portion of a cable network. The elements of the cable network include any components of a cable network, such as devices, links, homes, and poles.

Such devices can further include amplifiers, taps, and splitters.

The transformation engine crawls through map files, evaluates graphical data corresponding to devices and links in the respective maps, and identifies device-link connections between associated devices and links in each map. Device-link connections can be identified between associated devices and links in each map based on a proximity rule or other heuristic rules. The transformation engine further identifies inter-map connections between associated devices and links on different maps. Coordinates and edge elements on different maps are compared to correctly join the maps.

According to a further feature, a transformation engine generates and corrects a temporary hierarchical data structure until all connections are made and a final hierarchical data structure is obtained. In one implementation, the final hierarchical data structure is a tree or set of trees. The hierarchical tree data structure can be made up of tables of records or other type of relational data.

According to a further feature, the transformation engine can also identify tap-pole connections between associated taps and poles. Such tap- pole connections between associated taps and poles can be identified and made based on a proximity rule. Taps can also be associated with pedestals or other location markers instead of poles.

According to a further feature, a transformation engine can also identify pole-house connections between associated poles and houses. In one embodiment, pole-house connections between associated poles and houses are identified based on at least one of a proximity rule, graphical error data, graphical line data, and/or pole number information.

According to a further feature, the transformation engine can also identify street connections. The transformation engine determines relative locations of streets and map files, makes street connections for incomplete streets in a map and between maps, and associates street location and name information based on associated graphical street name data and graphical street data. The transformation engine can further make street-house connections. In a street-house connection, house address information is built based on graphical house number data and associated graphical street information.

According to a further feature of the present invention, a user interface is provided which enables a user to select which map files are imported by the transformation engine. For example, the user interface can provide a dialog window that lists available map files and includes buttons for controlling the selection of map files. In one example, map files can include but are not limited to the following file formats AutoCAD Drawing (DWG), drawing interchange format (DXF), or postscript (PS). The user interface can further enable a user to display a graphical representation of the hierarchical data structure. This enables a user or data manager to evaluate and analyze the hierarchical data structure.

The user interface further presents a menu of connect control options that enables a user to select one or more types of connections made by the transformation engine. For example, the user interface can include a drop down menu that lists the following options: whether device-link connections are to be made, whether inter-map connections are to be made, whether corrections are to be made to a temporary hierarchical structure, whether pole- tap connections are to be made, whether house-pole connections are to be made, and whether tombstones or other text descriptor information is to be connected or associated with elements. This menu can also include a connect all option for making all connections.

Finally, the user interface can present a menu of report options that enables a user to select a type of report to be generated based on the hierarchical data structure. In one example, a drop down menu can be provided to a user to enable a user to select a type of diagnostic report. These reports can include reports on map statistics, entity types statistics, a cable length report, connection statistics report, supporting entities report, unconnected entities statistics, and/or error reports.

Further embodiments, features, and advantages of the present invention, as well as the structure and operation of the various embodiments of the present invention are described in detail below with reference to accompanying drawings.

### BRIEF DESCRIPTION OF THE FIGURES

The present invention is described with reference to the accompanying drawings. In the drawings, like reference numbers indicate identical or functionally similar elements.

FIG. 1 is a diagram that illustrates an example of incomplete source graphical data.

FIG. 2 is a flowchart diagram of a transformative map crawler routine according to an embodiment of the present invention.

FIG. 3 is a flowchart diagram of a routine for transforming limited source graphical data to coherent transformed data according to an embodiment of the present invention.

FIG. 4 is a flowchart diagram that illustrates a cable network application of the transforming routine according to an embodiment of the present invention.

FIG. 5 is a block diagram of a transformative map crawler in a cable network application according to an embodiment of the present invention.

FIG. 6 is a flowchart diagram of the operation of the transformative map crawler of FIG. 5 according to an embodiment of the present invention.

FIGS. 7 to 16 are example diagrams that further illustrate aspects of the operation of the transformative map crawler of FIG. 5 according to the present invention.

FIG. 7 is a screenshot that shows one example map file in an AutoCAD file format having incomplete source graphical data.

FIG. 8 shows an example dialog window that enables a user to select map files to be imported to the transformative map crawler according to the present invention.

FIG. 9 shows an example menu that enables a user to select different types of connection operations to be carried out during the transformation routine in the transformative map crawler according to the present invention.

FIG. 10 shows an example coherent hierarchical data structure generated by a transformation routine according to the present invention.

FIG. 11 is a screen display that illustrates graphically an example coherent hierarchical data structure representative of a cable network as generated by a transformation routine according to the present invention.

FIG. 12 shows an example menu that enables a user to select different types of reports or statistics that can be generated from a coherent hierarchical data structure according to the present invention.

FIG. 13 shows an example connection statistics report.

FIG. 14 shows an example entity statistics report.

FIG. 15 shows an example unconnected devices report.

FIG. 16 shows an example customization dialog window that enables a user to create a template database.

FIG. 17 shows a flowchart diagram of an adaptive (intelligent?) transformation engine according to a further feature of the present invention.

FIG. 18 is an example computer system in which a transformative map crawler can be implemented according to an embodiment of the present invention.

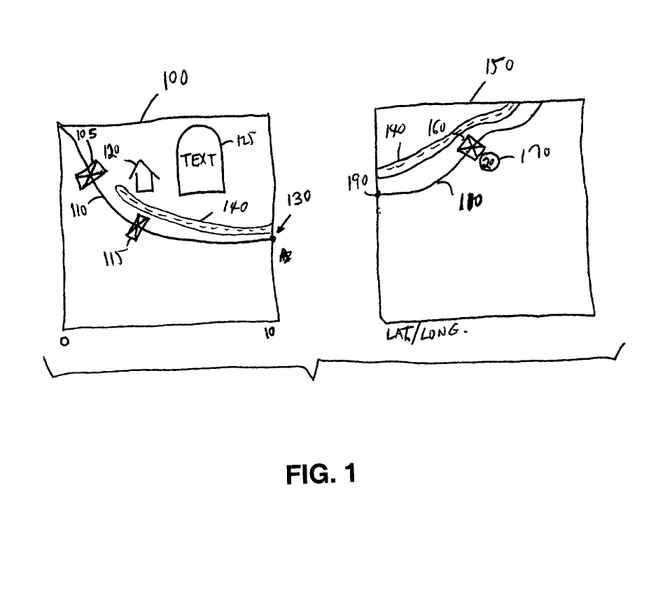

### DETAILED DESCRIPTION OF THE INVENTION

1. Overview

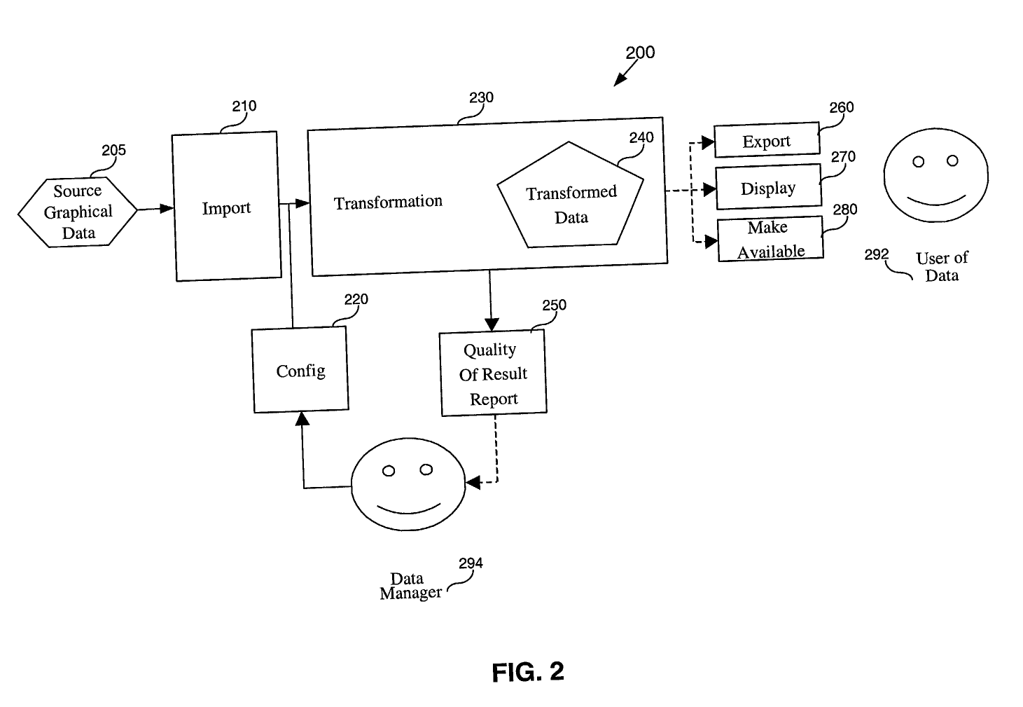

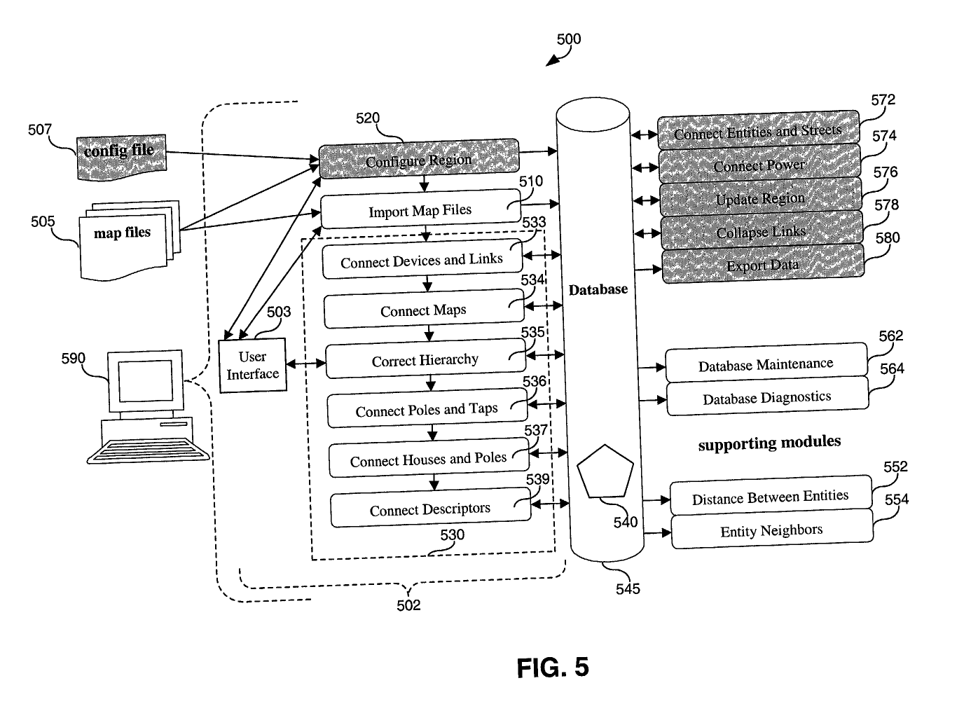

The present invention relates to data transformation. Incomplete source graphical data is transformed into coherent transformed data. First, a description of the data transformation process according to the present invention is described broadly with respect to FIGS. 2-4. Next, a description of the data transformation process in embodiments of the present invention related to a cable network application are described with respect to FIGS. 5-16.

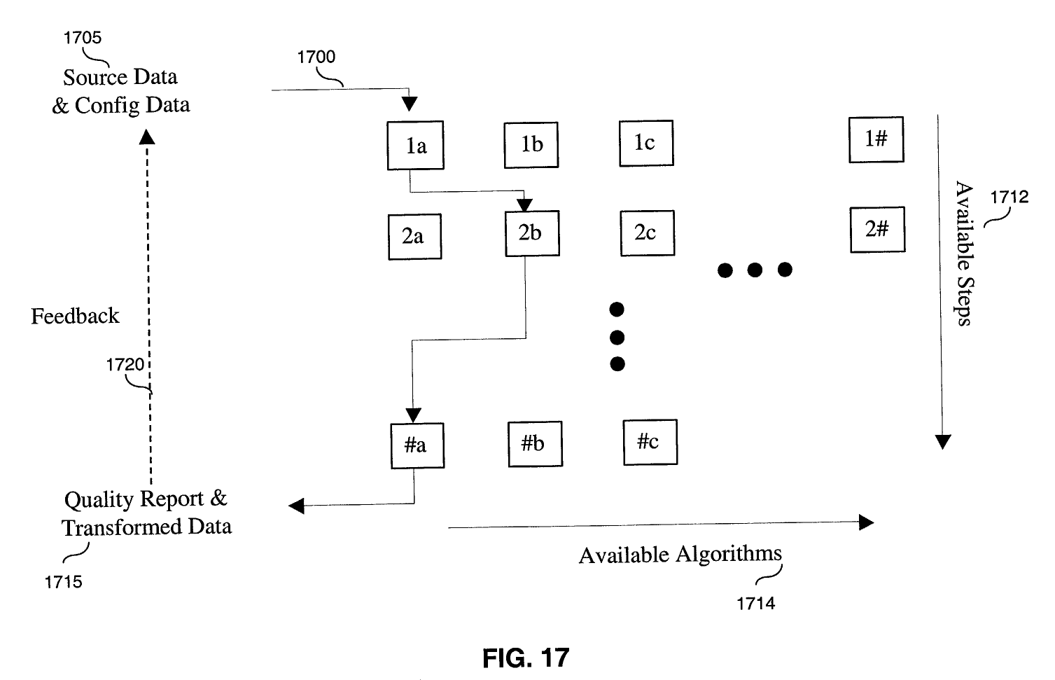

Finally, an adaptive data transformation process according to a further embodiment of the present invention is described below with respect to FIG. 17.

2. Terminology

The term “limited source graphical data” refers to any type of data provided in a format for graphical display. Such data can include but is not limited to graphical data provided in a file format. Example file formats include, but are not limited to, AutoCAD Drawing (DWG), Drawing Interchange Format (DXF), and PostScript (PS) format having graphical data which include objects. “Objects” is used broadly to refer to any type of information in graphical data including, but not limited to, primitives, blocks, layers, or other information provided in graphical data.

The term “map file” refers to a file having graphical data which represents a map.

The term “element” refers to any type of object in the limited source graphical data. For example, an element can include but is not limited to an object displayed in a map. In one application, an element represents any component shown in a map of a cable network.

The term “entity” refers to an object in the hierarchical data structure.

An entity includes information on an element that is ultimately displayed in the coherent transformed data.

3. Data Transformation

FIG. 2 is a flowchart diagram of a transformative map crawler routine 200 according to an embodiment of the present invention (steps 210-280). In step 210, source graphical data 205 is imported. In step 220, configuration information is determined. Steps 210 and 220 can be partly or fully automated. For example, a user of data 292 can select which source graphical data 205 is imported. Alternatively, source graphical data 205 can be automatically determined depending on a particular application. Similarly, user 292 (or data manager 294) can select or establish configuration data in step 220. This configuration data provides a template of the rules or criteria used in subsequent transformation of the source graphical data 205. Alternatively, the configuration information can be predetermined or automatically input.

In step 230, source graphical data 205 imported in step 210 is transformed to coherent transformed data 240. Transformed data 240 can then be used to generate a quality of result report (step 250) for review by a data manager 294. Data manager 294 can view quality of result reports obtained in step 250 and provide further feedback to the transformation process. For example, data manager 294 can adjust or add configuration information in step 220 to improve the quality of the transformation process for current source graphical data 205 or future source graphical data. In this way, a feedback loop leads to continual improvement of the transformation process in step 230.

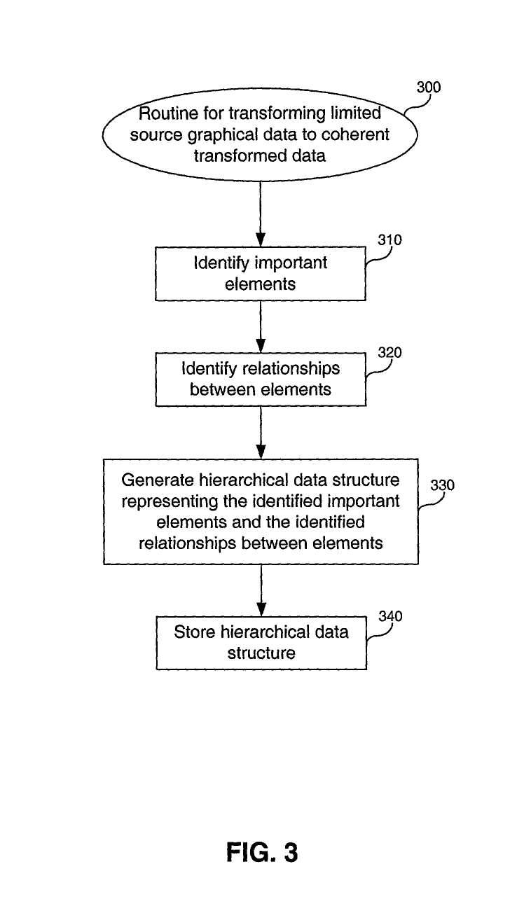

Once generated, coherent transformed data 240 can be exported (step 260). In one example, transformed data 240 is exported to an external application or other application that can make use of the transformed data 240. Transformed data 240 can also be output for display to user 292 (step 270). Transform data 240 can also be made available in step 280 to a user so that the coherent transformed data 240 can be viewed or edited by user 292 (step 280). Transformation process 230 is described in further detail below with respect to FIG. 3.

FIG. 3 is a flowchart diagram of a routine 300 for transforming limited source graphical data 205 to coherent transformed data 240 according to an embodiment of the present invention (steps 310-340). In step 310, important elements are identified in limited source graphical data 205. These important elements are identified in the graphical source data 205 based upon the configuration information provided in step 220. For example, the configuration information may identify certain types of elements which are important. Alternatively, all elements can be identified as important.

In step 320, relationships between elements are identified. In this step, logical connections are made between the identified important elements. A number of different types of relationships can be identified depending on the particular application. For example, certain elements may be associated with each other based upon their proximity or on the type or nature of the element. These relationships can then be identified based on proximity rules or other heuristic rules or criteria. Examples of relationships identified between elements and connections made are described with respect to further applications below.

In step 330, a hierarchical data structure is generated. The hierarchical data structure represents the identified important elements and the identified relationships between elements. In one embodiment, a hierarchical data structure is built as relationships are identified. This temporary hierarchical data structure is generated and edited as new relationships are identified. Corrections are then made to the temporary hierarchical data structure to ensure that relationships between elements are properly identified. A final hierarchical data structure is then generated. In step 340, the final hierarchical data structure is stored. For example, hierarchical data structure can be stored in any type of storage device including, but not limited to, memory. In one embodiment, hierarchical data structure is made up of relational data and stored in a database.

4. Cable Network Data Transformation

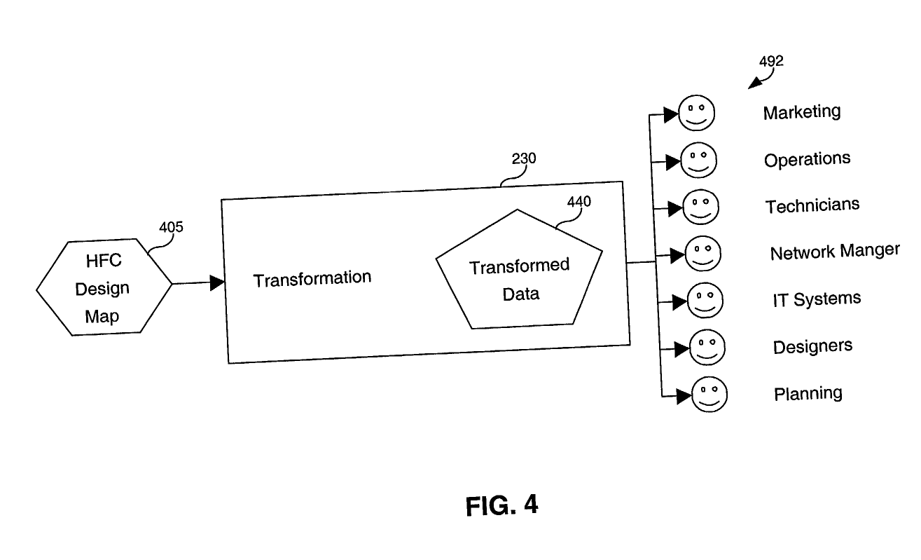

FIG. 4 shows an example application of transformation process 230 applied to a cable television network application. The source data 405 consists of HFC plant data made up of design maps which specify locations of nodes, amplifiers, power supplies, taps, fiber optic cable, wire, and other elements in a HFC distribution system, as well as buildings, poles, streets and other geographic features. Connections between these elements are not explicitly represented in the source graphic data, although they may be apparent to human readers that observe visual printouts or displays of the data.

Limited source graphical data representative of a HFC design map 405 is imported to the transformation process 230. The import process scans these maps and stores its contents in the database for future use.

Transformation process 230 transforms the HFC design map into a coherent transformed data structure 440. Transformation process 230 analyzes the data and determines probable connections between the elements resulting in a data structure 440 that more fully describes the HFC plant. This coherent transformed data structure 440 is representative of the cable network. The transformed data 440 includes information on the important elements in the cable network and relationships between the important elements in the cable network. These important elements and relationships between the important elements are determined by crawling through the limited source graphical data 405 having HFC design map information and determining associated elements and making appropriate inferences of associated elements.

Data in the transformed data structure 440 can be merged with data in other data sources in a wide variety of applications. A set of summary reports can be used to identify problems in the transformation process which can be corrected thereby improving the quality of the transformed data or otherwise tailoring into a particular user need.

According to a further feature of the present invention, the coherent transform data 440 can then be made available to different users depending on particular criteria and needs. In a cable network application, different users may benefit from having access to the coherent transformed data 440. FIG. 4 shows a number of areas 492 in which users may be involved including, but not limited to, marketing, network operations, cable network technicians, network managers, information technology (IT) systems operators, network designers, and cable network planners. Each of these users in areas 492 can then easily access coherent transformed data 440 to gain knowledge and understanding of the entire cable network. Further, as described below with respect to FIG. 17, each of these users may have a different criteria for the transformation process. A further feature of the present invention is that the transformation process 230 can be tailored to the specific needs of an end user. In this way, coherent transformed data 440 can be generated such that it is a maximum benefit to the end user. For example, a marketing study may have an interest in specific network elements, such as house location and street information. Transformation process 230 can then be configured to identify important elements related to house and street information as well as tailor relationships identified between such elements that is best suited for the marketing application. On the other hand, a cable network designer may need to have many elements in the network counted for and may have a need for very accurate associations between elements. In this case, transformation process 230 may be carried out such that many elements are identified and sophisticated proximity roles or heuristic rules are used in making associations between elements in the cable network.

Further embodiments of the present invention are described below with respect to FIGS. 5-16. These embodiments are described in detail with respect to transformation of data describing a cable network. The present invention is not intended to be limited to cable network data, however, and can be used in other applications, as would be apparent to a person skilled in the art given this description.

System 500 includes a map crawler tool 502. The map crawler tool 502 includes a user interface 503 coupled to a transformation engine 530. User interface 503 is used to control the sequence of operations and to select options as needed or desired by user. User interface 503 can be a graphical user interface, or any other type of user interface. One or more map files 505 are used to provide input to a transformation engine 530. Each map file 505 has limited source graphical data comprised of objects that define elements of a respective portion of a cable network. Each map file 505 has been generated to enable a respective map of a corresponding cable network portion to be visually output for printing or display.

A configuration file 507 can also be used to provide configuration data for data transformation engine 530. Map crawler tool 502 also includes an import map file module 510 and configuration module 520. In one embodiment, map crawler tool 502 is coupled to database 545. Transformation engine 530 transforms limited source graphical data in map files 505 to a hierarchical data structure 540. Hierarchical data structure 540 represents elements in the cable network and relationships between the elements.

As shown in FIG. 5, in one embodiment, transformation engine 530 includes the following modules: connect devices and links module 533, connect maps module 534, correct hierarchy module 535, connect poles and taps module 536, connect houses and poles module 537, and connect descriptors module 539. Each of these modules is optional and can be omitted or used in different combinations depending upon a particular transformation that is desired to be carried out. Other optional modules can be included in map crawler tool 502 as shown in FIG. 5. These modules include a connect entities and street module 572, connect power module 574, update region module 576, collapse links module 578, and export data module 580.

In one embodiment, a database maintenance module 562 and database diagnostics module 564 are provided to support database maintenance and diagnostic monitoring operations. Other modules can be used to support transformation carried out by transformation engine 530. Such modules referred to as supporting modules can include a distance between entities module 552 and entity neighbors module 554.

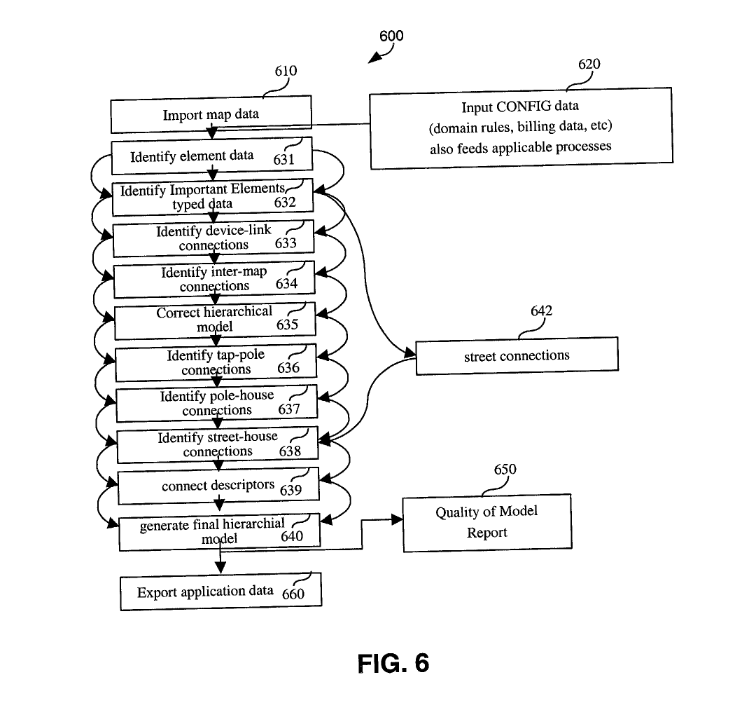

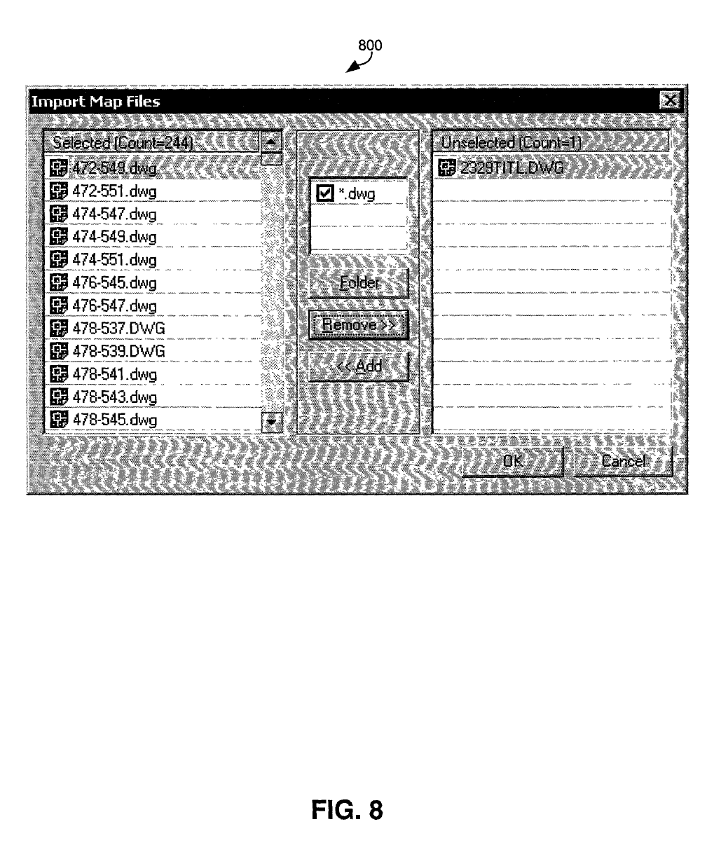

Map crawler tool 502 and each of its components, including user interface 503 and transformation engine 530, can be implemented in software, firmware, and/or hardware. Map crawler tool 502 can further be implemented in any type of computer system 590. For example, computer system 590 can include, but is not limited to, a single processor or multi-processor computer, or other type of processing device. The operation of system 500 and, in particular, map crawler tool 502, will now be described with respect to routine 600 shown in FIG. 6, and the example implementation shown in FIGS. 8-16.

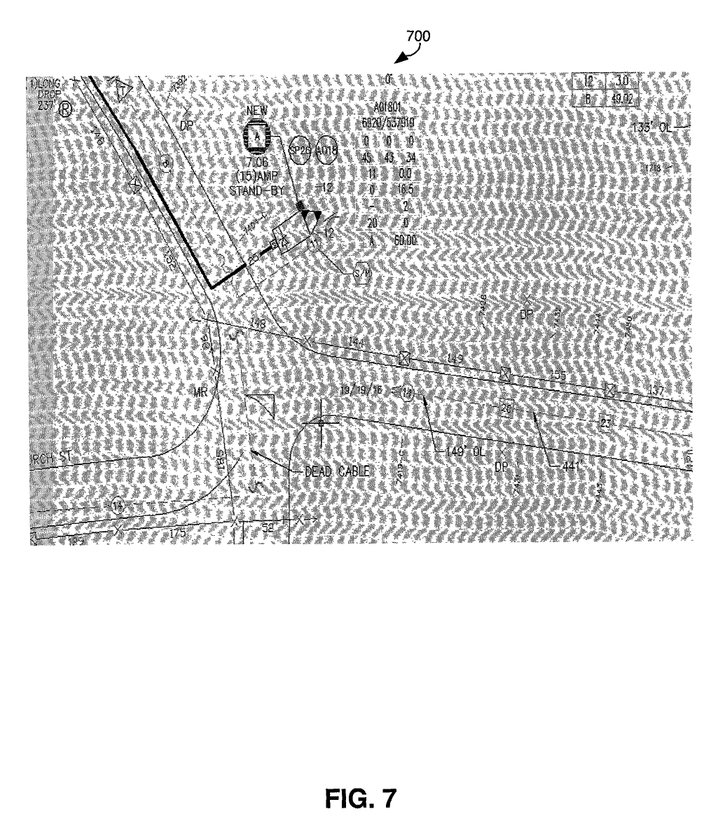

Map crawler tool 502 essentially follows a two-step process of importing data and connecting elements of the imported, limited graphical source data. Routine 600 begins with importing map data (step 610). Map data can be any type of limited source graphical data included in map files 505. FIG. 7 is a screen shot that illustrates map 700. Map 700 shows elements of a cable network which are visually perceptible to a user when map 700 is displayed or printed. In this example, map 700 is a screen shot as viewed through an AutoCAD viewer. Map 700, for example, is a display of limited graphical source data included in an AutoCAD drawing (.dwg) file format.

According to one embodiment, user interface 503 enables a user to select one or more map files 505 to be imported to transformation 530. FIG. 8 shows an example dialogue window 800. Dialogue window 800 enables a user to select desired map files 505. As shown in FIG. 8, unselected map files are listed on the right-hand side of dialogue window 800. Selected map files are listed in a pane on the left side of window 800. Control buttons such as “remove” and “add” buttons enable a user to remove and add map files from the selected list of map files.

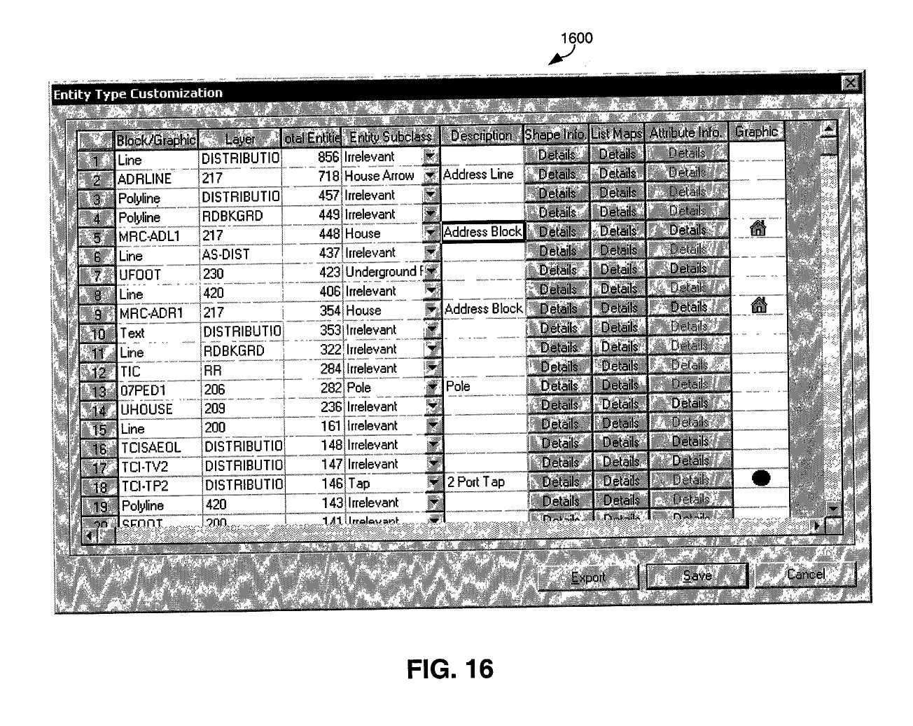

In step 620, configuration data is input. This configuration data can be predetermined, and/or can be defined or edited by a user. This configuration data, for example, can be included in configuration file 507. This configuration data is used to configure a template that defines content of entities to be included in the hierarchical data structure and potential relationships or connections between the entities. FIG. 16 shows an example dialogue window 1600. Dialogue window 1600 enables a user to view or edit configuration data included in configuration file 507. As shown in FIG. 16, configuration file 507 can include information which defines a template database for the hierarchical data structure. Transformation engine 530 then transforms graphical source data and map files 505 according to the configuration information, template database, and other configuration information. In one example, as shown in FIG. 16, the template database can include fields having block/graphic information, layer information, total entities information, entities subclass information, description information, shape information, list maps information, attribute information, and graphical icon information. Dialogue window 1600 can also include a “save” button for saving the configured template. An “export” button can also be included for later export of the data in the generated hierarchical data structure to another application. Other configuration information can include domain rules, billing data, etc.

Once selected map files have been imported and configuration information, if any, has been input, a connect process 630 begins. Connect process 630 can include steps 631-642. In step 631, transformation engine 530 identifies element data. Individual elements are identified in map files 505 and read into a temporary hierarchical data structure. In step 632, important elements are identified by transformation engine 530. Configuration data and heuristic rules can be used to identify and classify important elements.

In step 633, device-link connections are identified. For example, connect devices and links module 533 identifies and makes device-link connections. Proximity and other heuristic rules are used to associate devices and links. For example, two devices might be considered connected if they are closer to each other than to any other devices, and if configuration data indicates that these two types of devices may be connected, and no other constraints or heuristics have been violated.

In step 634, inter-map connections are identified. For example, connect maps module 534 can compare coordinate spaces and edge elements to correctly join elements and make connections between elements in different maps.

In step 635, the temporary hierarchical model is corrected. For example, correct hierarchy module 535 can use direction, design rules, and links to organize device-link connections into a set of trees. These trees show which devices send or receive data from which other devices.

In step 636, tap-pole connections are identified. Connect poles and taps module 536 can carry out the step. Taps are associated with their pole or pedestals, in event that a home is easier to associate with poles. In step 637, pole-house connections are identified. For example, connect houses and poles module 537 can carry out step 637. Arrows, lines, poles and/or proximity rules are used to associate poles to appropriate houses.

In step 638, street-house connections are identified. In step 642, street connections are made. In one example, connect entities and street module 572 performs each of steps 638 and 642. In step 642, locations and connections between streets are determined and associated with street names. In step 638, an address is constructed using house number and associated street information. The information identified in street connections and street-house connections is further added to the temporary hierarchical data structure.

In step 639, descriptors are connected. For example, connect descriptor modules 539 can carry out step 639. Text on a map in map files 505 is heuristically associated with corresponding elements. For example, maps may specify model numbers, battery capacity, and other technical parameters associated with specific devices.

In step 640, a final hierarchical model is generated. Transformation engine 530 generates the final hierarchical model and stores it, in one implementation, as a set of tables of records 540 in database 545. The final hierarchical model represents a model of a RF plant from nodes to fully addressed homes. This model of the RF plant is built, validated and defects are identified during the transformation. In this way, coherent transform data is available for generating quality model reports to a data manager or user (step 650), export as data for other applications (step 660), display or other applications.

Further aspects of the operation of modules in system 500, and including modules in transformation engine 530, are further described below with respect to an example implementation.

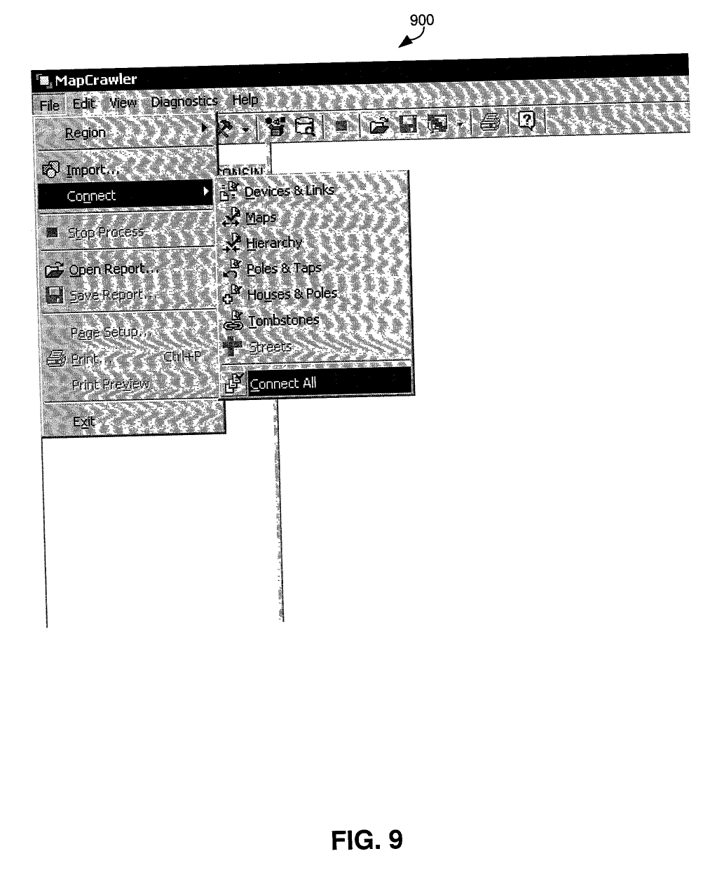

According to a further feature of the present invention, user interface 502 can provide a user with a drop-down menu that enables the user to select all or specific types of connections to be made during transformation of data. For example, FIG. 9 shows a screen shot of one drop-down menu 900 that includes control options. These connect control options enable a user to direct transformation engine 530 to make one of eight types of connections. Devices and links connect control option directs transformation engine 530 to make devices-link connections, as described with respect to step 633. Maps connect control option directs transformation engine 530 to make inter-map connections as described with respect to step 634. Hierarchy connect control option directs transformation engine 530 to correct a hierarchical model as described with respect to step 635. Poles and taps connect control option directs transformation engine 530 to identify tape pole connections, as described with respect to step 636. Houses and poles connect control option directs transformation engine 530 to make houses and pole connections as described with respect to step 637. Tombstones connect control option directs transformation engine 530 to make descriptor connections as described with respect to step 639. Streets connect control option directs transformation engine 530 to make street connections and street-house connections, as described with respect to steps 642 and 638, and finally, connect all connect control option directs transformation engine 530 to perform all of the connections described with respect to steps 633 through 642.

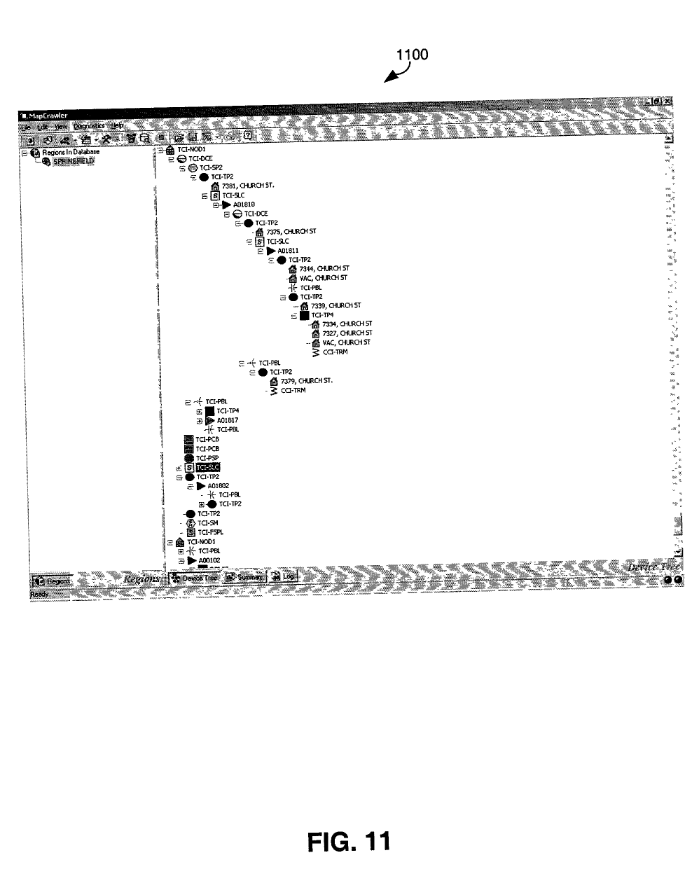

FIG. 11 shows an example screen shot 1100, illustrating graphically an example coherent hierarchical data structure representative of a cable network generated by transformation engine 630 and routine 600 according to the present invention.

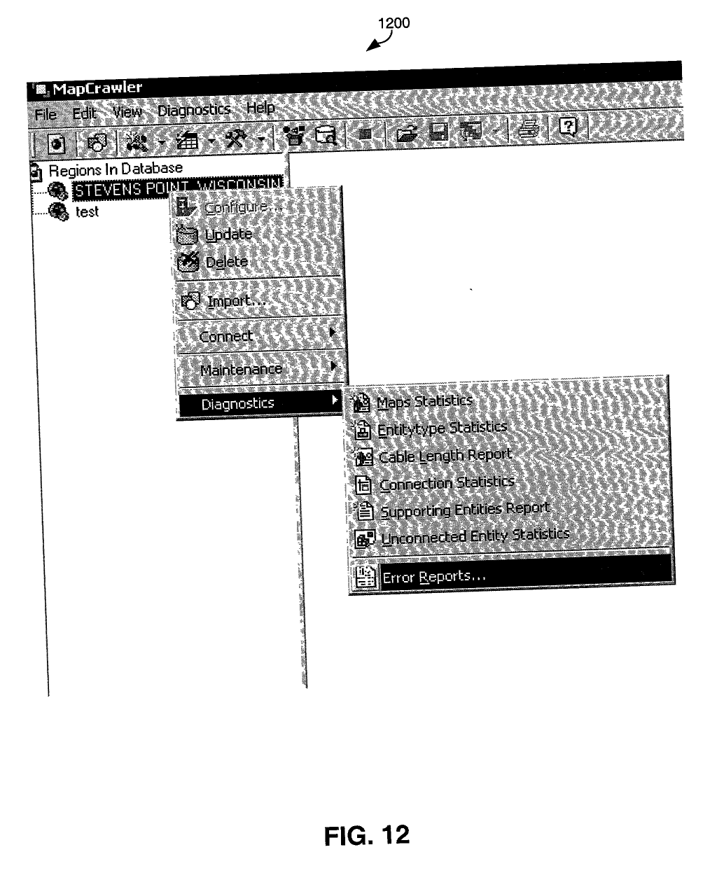

FIG. 12 shows an example screen display 1200 having an example menu that enables a user to select different types of reports or statistics that can be generated from a coherent hierarchical data structure according to the present invention. This menu includes a diagnostics menu option that lists the following additional menu options: map statistics, entity type statistics, cable length report, connection statistics, supporting entities report, unconnected entities statistics report, and error reports. Selecting either of these buttons generates an appropriate corresponding report.

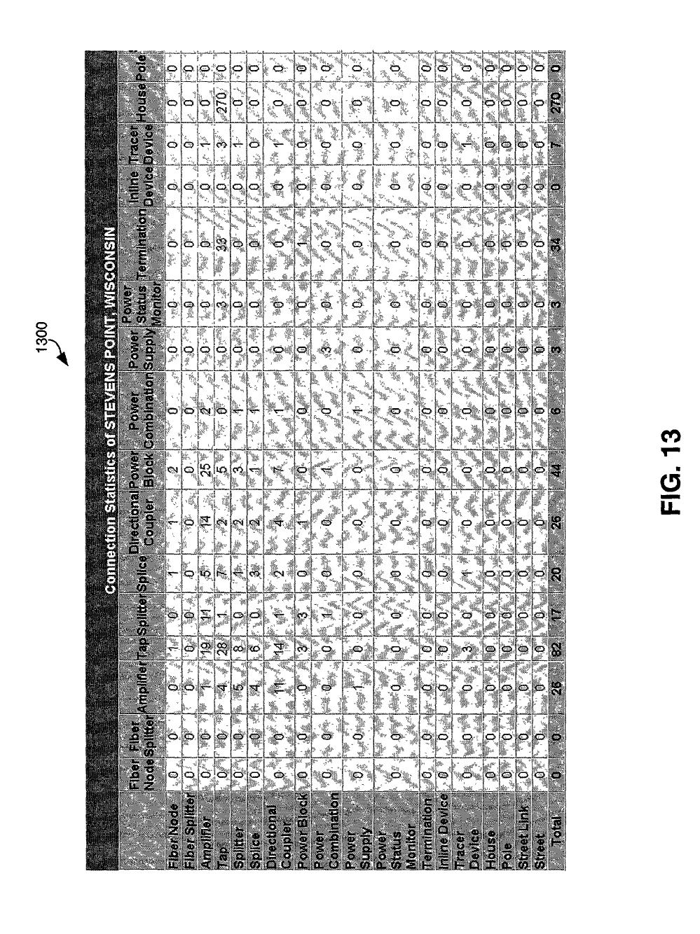

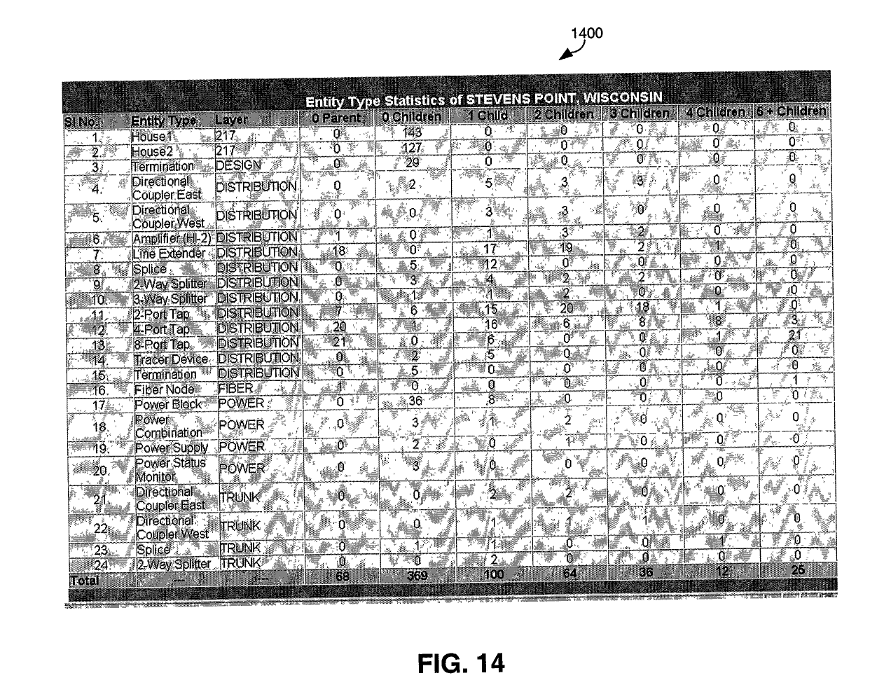

FIG. 13 shows an example connection statistics report 1300. Report 1300 displays a matrix representing connectivity of the blocks included in the generated data structure. FIG. 14 shows an example entity type statistics report 1400. This report includes connectivity of blocks information, including connections between fiber node, fiber splitter, amplifier, tap, splitter, splice, directional coupler, power block, power combination, power supply, power status monitor, termination, end-line device, tracer device, house, pole, street link, and street information. This report includes entity type information, layer information, parent and children information.

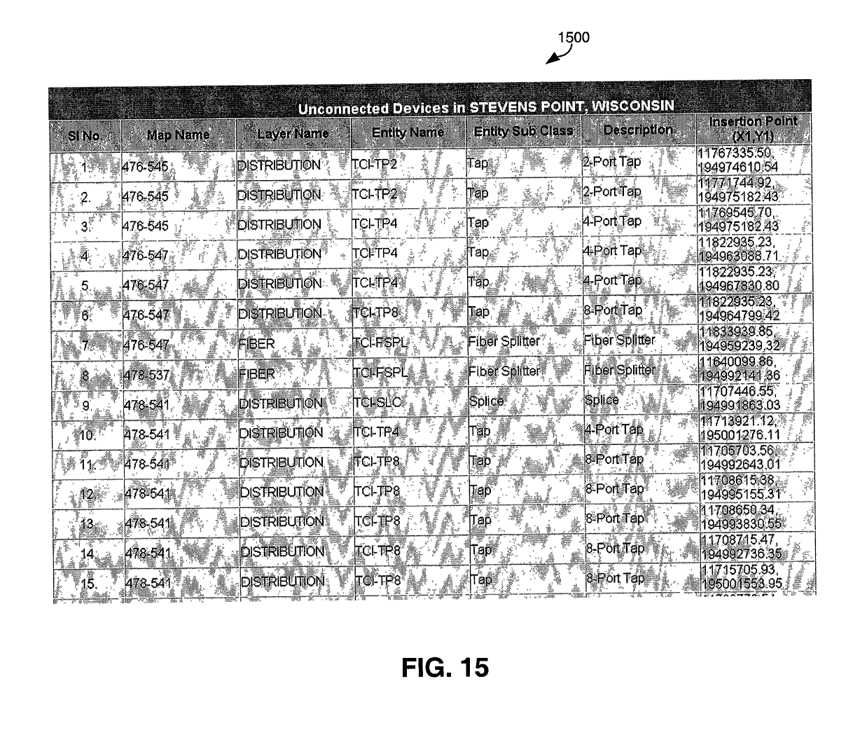

FIG. 15 shows an example unconnected devices report 1500. This report 1500 lists devices/blocks that remain unconnected. This report can include identifying information such as map name, layer name, entity name, entity subclass, description, and insertion point information.

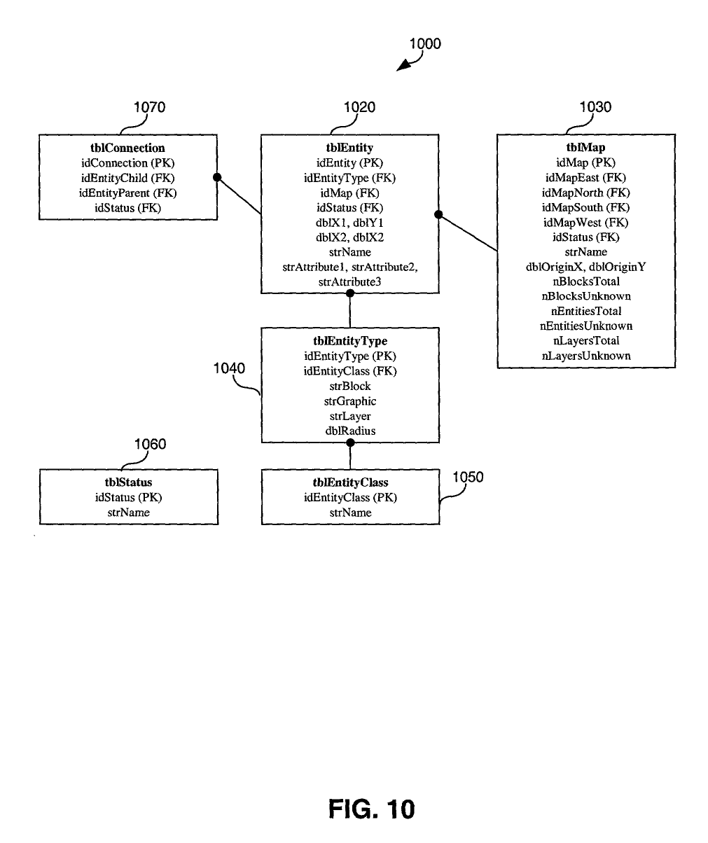

FIG. 10 shows an example set of table records 1000 that store information representing the generated hierarchical data structure 540. In particular, the tables of records 1000 include tables of records 110-160. Tables 1000 are a high-level data model of the system and are further described below with respect to an example implementation.

5. Example

This invention provides a process for analyzing vector graphic files to obtain hierarchical data structures which can then be used for subsequent processes. The primary objects and advantages of this invention include:

1. When applicable, it identifies the direction of connections.

2. It identifies connections between objects.

3. The resulting information can be integrated with other information systems, including:

a. geographic information systems

b. monitoring systems

c. dispatch and workforce management systems

5.1. List of Drawings

The following drawings are further described in section 5. 1.

1. Block Diagram (FIG. 5)

2. Data Model (FIG. 10)

5.2. List of Modules

The following modules are described in section 5.2.

1. Import Map Files

2. Connect Devices and Links

3. Connect Maps

4. Correct Hierarchy

5. Connect Poles and Taps

6. Connect Houses and Poles

7. Connect Descriptors

8. Database Diagnostics

9. Distance Between Entities

10. Entity Neighbors

6. Description of Main Embodiment

6.1 Drawing Descriptions

The following subsections contain detailed descriptions of each drawing.

6.1.1. Block Diagram

FIG. 5 is a high-level block diagram of the system. Shaded items may be included in future versions of the system. A graphical user interface (GUT) is used to control the sequence of operations, and to select options when necessary. The system uses a set of map files as input. The system may use a configuration file to specify additional information. The primary modules perform the major steps in the process, and are described in more detail in section 6.2. The heavy arrows between modules indicate the typical processing order. Each primary module uses the results of prior modules. The system uses a database for storage and retrieval of data from the map files; most modules both read to and write from the database. The primary modules access the supporting modules, which are also described in section 6.2.

6.1.2. Data Model

Drawing 2 (FIG. 10) is a high-level data model of the system. Each square box represents a table of records; each record has a value for each of the attributes listed in the box. The initial letters of each attribute indicate the type of data it contains. “(PK)” indicates primary keys, which have unique values in the table. “(FK)” indicates foreign keys, which refer to records in other tables.

| Table | Contents | Comment |
|---|---|---|
| tblEntityClass | A record for each broad | The EntityClass determines |
| | category of object, such as | which modules process an Entity. |
| | device, link, house, pole. | |
| tblEntityType | A record for each specific | Each EntityType is defined by a |
| | type of object, such as | combination of primitive, class, |
| | amplifier, tap, splitter, | and block, and is associated with |
| | | an EntityClass. |
| tblMap | A record for each data file. | |
| tblEntity | A record for each object of | Each Entity has a name, position, |
| | interest that is read from a | and possibly other attributes, and |
| | data file. | is associated with a Map and an |
| | | EntityType. |
| tblConnection | A record for each connection | Every Connection is associated |
| | between objects. The | with two Entities. |
| | connections are obtained by | |
| | the modules described below. | |
| tblStatus | A record for each status value | |
| | used in one of the other | |
| | tables. | |

The tables are connected by lines indicating relationships between the tables, and the presence or absence of a dot on the line indicates the cardinality of the relationship. For example, the line between tblMap and tblEntity indicates that every Entity is associated with a single Map, and each Map may be associated with many Entities.

6.2. Module Descriptions

The following subsections contain detailed descriptions of each module, including the module's inputs, outputs, possible enhancements, and pseudocode.

6.2.1. Import Map Files Module 510

This module reads a set of map files and stores all necessary data in the database. Lines consisting of multiple segments are processed as multiple lines.

Inputs:

1. list of map file names.

Outputs:

1. returns the number of map files successfully read.

2. creates Entity records in database.

3. log unknown layers, blocks, and entities found in each file

Possible Enhancements:

1. use of additional extended data embedded in map files.

2. multiple map file format.

Processing.

The following pseudocode defines the operation of one example of this module 510:

// *** start pseudocode for ImportMapFiles ***
create timestamped log entry for start of module processing
for each map file F

create Map M and set M.status=unread
open F (if problems, M.status=notfound)
for each layer L in M

increment M.nLayersTotal
if no EntityType contains Layer L

increment M.nLayersUnknown
generate log entry with warning

next L

for each block B in M

increment M.nBlocksTotal
if no EntityType contains Block B

increment M.nBlocksUnknown
generate log entry with warning

next B

for each entity datum D in M

increment M.nEntitiesTotal
if D is INSERT

| | |
|---|---|
| if no | EntityType contains Block and Layer for D |

increment M.nEntitiesUnknown
generate log entry with warning
continue with next D

else

create Entity E and set E.status=unprocessed

else

| | |
|---|---|
| if no | EntityType contains Layer for D and null Block |

increment M.nEntitiesUnknown
generate log entry with warning
continue with next D

if D is ARC

create Entity E and set E.status=unprocessed

else if D is LINE

create Entity E and set E.status=unprocessed

else if D is LWPOLYLINE

create Entity E and set E.status=unprocessed

else if D is POLYLINE

create Entity E and set E.status=unprocessed

next D
set Map.status=read

next F

create timestamped log entry for end of module processing
// *** end pseudocode for ImportMapFiles ***

6.2.2. Connect Devices and Links

This module connects devices and links within a single map; Connections that cross map boundaries are handled separately. More precisely, this module may create Connections that cross boundaries depending on the algorithm used to determine neighbors, but the ConnectMaps module is designed to handle difficulties at boundaries.

Inputs:

1. requires Entity records in database for unprocessed devices and/or links to be connected.

Outputs:

1. creates Connection records in database for connections between devices and/or links.

Possible enhancements:

1. handle problems when a link connects two devices of the same EntityType and neither one appears to be the parent (currently resolved by CorrectHierarchy module).

Processing.

The following pseudocode algorithm defines this module:

// *** start pseudocode for ConnectDevicesAndLinks ***
create timestamped log entry for start of module processing
for each Map M

if M.status!=read, continue with next Map

create timestamped log entry for start of M
initialize Queue of unprocessed Entities
for each EntityType T with EntityClass=={device,link}
(sorted by proximity to head end)

// assertion: queue is empty
find all Entities with status==unprocessed

in Map M with EntityType T

add them to Queue
// process until queue is empty
for each Entity E in Queue

remove E from Queue
if E.status==processed

continue with next Entity E

set E.status=processed
find all neighboring Entities with EntityClass=={device,link}
(sorted by distance to E)
for each neighbor N1 (sorted by distance)

// reject neighbor if it is closer to another neighbor
for each nearer neighbor N2 (sorted by distance)

// assertion: distance(N1,E) > distance(N2,E)
if distance(N1,E) <distance(N1,N2)

continue with next neighbor N1

next N2

// N1 is a child of E, so create Connection
create Connection C from E (parent) to N1 (child)
set C.status=directed
add N1 to Queue
next N1

next E

next T

set Map.status=connected

create timestamped log entry for end of Map M

next M

create timestamped log entry for end of module processing
// *** end pseudocode for ImportMapFiles***

6.2.3. Connect Maps

This module connects links across the boundary between two maps. More precisely, the ConnectDevicesAndLinks module may create some Connections that cross boundaries, but this module is designed to address problems that occur at boundaries.

Inputs:

1. requires Entity records in database for links to be connected

Outputs:

1. creates Connection records in database for connections between links.

Possible Enhancements:

1. attempt to determine direction of each Connection.

Processing.

The following pseudocode algorithm defines an example of this module 534:

// *** start pseudocode for ConnectMaps ***
// this algorithm assumes that boundary Entities are links, not devices
create timestamped log entry for start of module processing
for each boundary B between Maps M1 and M2

create timestamped log entry for start of boundary between M1 and M2
// E is a boundary Entity iff distance(E,boundary) < specified maximum

// unless the end nearest boundary is already in a Connection

// sort by X (Y) coordinate for horizontal (vertical) boundaries
find all boundary Entities in M1 with EntityClass==link
and without Connections at end nearest boundary
(sorted by EntityType and coordinate)
find all boundary Entities in M2 with EntityClass==link
and without Connections at end nearest boundary
(sorted by EntityType and coordinate)
for each EntityType T in either boundary set

for each boundary Entity E1 with E1.EntityType==T in M1
find closest boundary Entity E2 with E2.EntityType==T in M2

create Connection C from E1 to E2
set C.status=undirected

// future version might attempt to determine Connection direction
// see pseudocode below

next E1

next T

create timestamped log entry for end of boundary between M1 and M2
next B

create timestamped log entry for end of module processing
// *** start pseudocode for ConnectMaps ***

Another version may attempt to determine the appropriate direction for each Connection; the following pseudocode might be used:

// ** decide which Entity is parent and which is child
set F1=False, F2=False
// we expect to find one Entity, with E1 as child
find Entity E3 in M1 with Connection C1 to E1
if multiple Entities, generate warning
find all Connections in M1 involving E3
if any have E3 as the child, set F1=True
// we expect to find one Entity, with E2 as child
find Entity E4 in M2 with Connection C2 to E2
if multiple Entities, generate warning
find all Connections in M2 involving E4
if any have E4 as the child, set F2=True
if (F1 == F2)

// unable to determine which Entity is parent, so guess
set F2 = not F1
generate warning

if F1

// E1 is parent in boundary Connection
edit C1 to be from E3 (parent) to E1 (child)
create Connection with status=directed

from E1 (parent) to E2 (child)

edit C2 to be from E2 (parent) to E4 (child)

else

// E2 is parent in boundary Connection
edit C2 to be from E4 (parent) to E2 (child)
create Connection with status=directed

from E2 (parent) to E1 (child)

edit C1 to be from E1 (parent) to E3 (child)

6.2.4. Correct Hierarchy—Module 535

This module scans the database to identify and if possible correct errors, inconsistencies, or incomplete data.

Inputs.

1. requires Entity and Connection records in database.

Outputs.

1. corrects reversed Connection records.

Possible Enhancements.

1. search for entities with multiple parents (likely sources of error).

Processing.

The following pseudocode algorithm defines an example of this module 535:

// *** start pseudocode for CorrectHierarchy ***
create timestamped log entry for start of module processing
initialize Queue of unprocessed Entities
for each EntityType T with EntityClass={device,link}
(sorted by proximity to head end)

// assertion: queue is empty
find all Entities with status==processed in Map M with EntityType T
add them to Queue
// process until queue is empty
for each Entity E in Queue

remove E from Queue
if E.status==verified

continue with next Entity E

E.status = verified
for each Connection C where C.status!=verified

if C.parent!=E

swap C.parent and C.child

If assertion: C now has correct direction
add C.child to Queue
C.status = verified
next C

next E

next T

create timestamped log entry for end of module processing
// *** end pseudocode for CorrectHierarchy ***

6.2.5. Connect Poles and Taps Module 536

This module connects each tap to the appropriate pole.

Inputs:

1. requires Entity records in database for poles and taps to be connected.

Outputs:

1. creates Connection records in database for connections between poles and taps.

Possible Ehancements:

1. connecting to taps on <4 adjacent maps.

Processing.

The following pseudocode algorithm defines an example of this module 536:

// *** start pseudocode for ConnectPolesAndTaps
create timestamped log entry for start of module processing
for each Entity T with EntityClass=tap

find all neighboring Entities with EntityClass=pole

(sorted by distance to T)

where N is a neighbor of T iff distance(N,T) < specified maximum
// neighborhood should include <3 adjacent maps if P is near boundary
create Connection with status=directed from T (parent) to nearest

neighbor pole (child)

next T

create timestamped log entry for end of module processing
// *** start pseudocode for ConnectHousesAndPoles

6.2.6. Connect Houses and Poles Module 537

This module connects each house to the appropriate pole.

Inputs:

1. requires Entity records in database for houses and poles to be connected.

Outputs:

1. creates Connection records in database for conenctions between houses and poles.

Possible Enhancements:

1. connecting houses to poles on <4 adjacent maps.

2. create Connections from house to tap instead of from house to pole

Processing.

The following pseudocode algorithm defines this module:

// *** start pseudocode for ConnectHousesAndPoles
create timestamped log entry for start of module processing
for each Entity H with EntityClass=house

find all neighboring Entities with EntityClass=pole (sorted by distance

to H)

where N is a neighbor of H iff distance(N,H) < specified maximum
// neighborhood should include <3 adjacent maps if H is near boundary
for each neighbor N

// determine angle and distance from House to neighboring Pole
angle = arctan( (m2 − m1) / (1 + m2m1) ) where m1,m2 are

slopes

next P

find best neighbor P
create Connection with status=directed from P (parent) to H (child)
next H

create timestamped log entry for end of module processing
// *** end pseudocode for ConnectHousesAndPoles

6.2.7. Connect Descriptors Module 539

This module connects each “tombstone” descriptor with the device it describes.

Inputs:

1. requires Entity records in database for tombstones, devices, houses, poles, and taps.

2. requires Connection records in database for connections from houses to poles, poles to taps, and taps to devices (possibly via other devices and links).

Outputs:

1. creates Connections in the database between devices and tombstones

Possible Enhancements:

Processing.

The following pseudocode algorithm defines an example of this module 539:

// *** start pseudocode for ConnectDescriptors
create timestamped log entry for start of module processing
for each Entity T with EntityClass=tombstone

get amplifier (stored as Attribute)
for each House H that has the same amplifier (stored as Attribute)

follow Connections upstream until amplifier is found
next H

if all Houses do not point to the same amplifer

generate warning in log
select amplifier with the most Houses

create Connection with status=directed from amplifier (parent) to T

(child)

next T

create timestamped log entry for end of module processing
// *** end pseudocode for ConnectDescriptors

6.2.8. Database Diagnostics Module 564

This module contains diagnostics used to evaluate the map files and the resulting network hierarchy, including:

1. table of summary statistics for each map file (see example), including:

a. number of sections, tables, layers, blocks, and entities

b. number of unknown layers, blocks, and entities encountered

c. the number of entities belonging to each EntityClass and EntityType

| | | | | | # | | # | | # un- | Entities | | | | Entities | |
|---|---|---|---|---|---|---|---|---|---|---|---|---|---|---|---|
| | Summary | # | # | # | unknown | # | unknown | # | known | by | | | | by | |
| MapFile | Data | sections | tables | layers | layers | blocks | blocks | entities | entities | Subclass | device | link | . . . | Type | . . . |
| 101-123.dxf | — | | | | | | | | | — | | | | — | |
| 101-123.dxf | — | | | | | | | | | — | | | | — | |
| . . . | — | | | | | | | | | — | | | | — | |
| Total | — | — | — | — | | — | | | | — | | | | — | |

2. table of summary statistics for each Entity Type (see example).

| | 0 | 1 | 2+ | 0 | 1 | 2+ |
|---|---|---|---|---|---|---|
| | parents | parent | parents | children | child | children |
| EntitySubclass | | | | | | |
| Device | | | | | | |
| Link | | | | | | |
| ... | | | | | | |
| Total | | | | | | |
| EntityType | | | | | | |
| ... | | | | | | |
| Total | | | | | | |

3. list of Entities that have multiple parents (every Entity should have 0 or 1 parents)

4. matrix showing number of Connections between each EntitySubclass (see example)

| | | | | | | | | |
|---|---|---|---|---|---|---|---|---|
| Parent | Child | node | amp | tap | pole | house | . . . | Total |

| | | | | | | |
|---|---|---|---|---|---|---|
| Node | 1 | 4 | 0 | 0 | 0 | 5 |
| Amp | 0 | 3 | 3 | 0 | 0 | 6 |
| Tap | 0 | 0 | 5 | 5 | 0 | 10 |
| Pole | 0 | 0 | 0 | 0 | 20 | 20 |
| House | 0 | 0 | 0 | 0 | 0 | 0 |
| . . . | | | | | | |
| Total | 1 | 7 | 8 | 5 | 20 | 31 |

5. tree-browser to view hierachical relationships between devices

Possible Enhancements:

1. facility for plotting positions (perhaps by outputting AutoCAD files), to help isolate problem areas or features, such as devices with multiple parents, links without connections, etc.

6.2.9. Distance Between Entities Module 552

This module computes the distance between a pair of Entities.

Inputs:

1. identifiers for two Entities.

Outputs:

1. distance between the two Entities.

Possible Enhancements:

1. custom distance measures for particular entity types (via stored procedures?), where distance may depend on orientation, etc.

2. domain knowledge regarding entity types than can and cannot be connected; devices that cannot be connected could return maximum distance.

Processing.

The following pseudocode defines the operation of an example of this module 552:

for Entities E1 and E2 with EntityTypes T1 and T2

if special distance measure exists for T1 and T2

use it to determine distance

else

compute distance D between E1 and E2
D = D − (E1.radius + E2.radius)

end module

6.2.10. Entity Neighbors Module 554

This module uses indexing and efficient database queries to identify the set of Entities that are “near” a given Entity. The goal is to improve overall system performance by computing exact distances only for Entities that are known to be in the neighborhood. The module can be configured to use one of several approaches, detailed below, via a separate procedure call.

Inputs:

1. identifier E for one Entity.

2. radius R of neighborhood (square radius rather than circular radius).

Outputs:

1. list of identifiers for neighboring Entities.

Processing:

The module can be configured to any of the following approaches:

1. return all Entities in the same Map as E

2. every Entity N that satisfies one of the four following conditions:

((E.x1−R)<N.x1<(E.x1+R)) and ((E.y1−R)<N.y1<(E.y1+R))

((E.x1−R)<N.x2<(E.x1+R)) and ((E.y1−R)<N.y2<(E.y1+R))

((E.x2−R)<N.x1<(E.x2+R)) and ((E.y2−R)<N.y1<(E.y2+R))

((E.x2−R)<N.x2<(E.x2+R)) and ((E.y2−R)<N.y2<(E.y2+R))

(Entities can be indexed by coordinate values, so these queries should be very fast.)

3. every Entity N in the same Map as E that satisfies one of the four conditions above.

Possible Enhancements:

1. additional neighborhood algorithms designed to improve system performance.

2. custom distance measures for particular entities (stored procedures), where distance may depend on orientation, etc.

3. domain knowledge regarding entity types than can and cannot be connected; devices that cannot be connected would never be neighbors.

Alternative Embodiments

The following alternatives are also possible, alone or in combination.

1. The system could be applied to other industries, not just cable distribution systems.

2. The graphical user interface could be replaced with other interfaces.

3. The system could read any vector graphic file format, not just AutoCAD map files.

4. The database could include other fields and tables.

5. The modules could be applied in other sequences.

6. Some applications might require a subset of modules, or additional modules.

7. The system could be implemented using many other programming languages, databases, operating systems, and hardware.

8. The system could maintain all data directly, rather than using a database for storage and retrieval.

7. Adaptive Transformation Engine

FIG. 17 is a flowchart diagram of an adaptive transformation engine according to a further embodiment of the present invention. The connection operations carried out in transformation engine 530 are performed in a series of steps 1712. Each of these steps can be categorized as a series of available steps numbered 1, 2, etc., to any number (n, listed as ##). Within each step, a number of different algorithms can be selected depending on the particular proximity rule, configuration information, or other design criteria or users selection. This is illustrated in FIG. 17 by listing a number of available algorithms 1714 for each step 1712. Each of the different algorithms is denoted by a letter A, B, C, etc. In this way, the transformation carried out by transformation engine 530 in this embodiment, can be thought of as represented as series of steps 1, 2, 3 . . . #, each with characteristic inputs, outputs and measures of quality. Furthermore, each processing step 1712 may be implemented using a variety of alternative algorithms (A, B. C . . . #) 1714. Some steps 1712 may have many alternatives, while other may only have one or few alternatives. The algorithms may vary a number of ways, including cost to design and implement, number and types of errors introduced, degree of user supervision and intervention required, etc.

In general, if there are X steps, each of which can be implemented with Y algorithms, then there are Y to-the-X-power possible permutations. Thus, it is possible to use feedback 1720 from quality reports 1715 to determine which set of steps (i.e., a path) is most appropriate for a particular set of source data and configuration data 1705. Furthermore, product managers can use similar reports to help determine how to allocate development resources so as to maximize performance and minimize developmental cost. This selection of steps and algorithms can also be modified based on the level of quality that is required for a particular application. For example, a marketing application may not require as much sophisticated transformation algorithms as a network operation where accuracy and quality are important.

Specific applications in the cable network industry further include: creating a coherent transformed data structure which supports customer data integration for services, billing etc., creating a coherent transformed data structure with street address correction based on additional information from the maps or other information, and associating elements with networking protocol layers and surfaces. Other applications of the map crawler include error identification and correction. Such error identification and correction can include associating real time and historical status information, status monitoring of the display, interpretation of sensor data, and root cause analysis. Another application is power management. If the power supply is down supplied homes are also down. Reorganization to optimize power usage across the network can be performed based on the coherent transformed data. Another application of the map crawler tool and data transformation is provisioning, maintenance and plant improvement. Service availability, where to put new devices, node fracturing as when bandwidth requirements increase add nodes to increase the supply, auto upgrade for new technologies prioritization and scheduling. For example fiber to the curb. Finally an application in the cable network industry is the use of data transformation changing the data model of format to a different destination (coordinate transformation correction and auto language translation).

The present invention is not limited to cable network applications and can indeed used in any application requiring data transformation. Examples of other applications or industries include the following:

any applications involving maps or topologies of systems for communication or distribution (energy, data, materials).

any applications involving partial representation of an underlying data topology. Specific examples include but are not limited to wireless and wire communications for data, voice, video, power, etc., waste water or water management, transportation systems, biological applications such as cardiac systems that model blood distribution and living systems, and circuit board layouts.

8. Example Implementations

A. Example Hardware/Software/Firmware Implementations

The present invention (for example, map crawler 502) can be implemented in hardware, software, firmware, and/or combinations thereof, including, without limitation, gate arrays, programmable arrays (“PGAs”), fast PGAs (“FPGAs”), application-specific integrated circuits (“ASICs”), processors, microprocessors, microcontrollers, and/or other embedded circuits, processes and/or digital signal processors, and discrete hardware logic. The present invention is preferably implemented with digital electronics but can also be implemented with analog electronics and/or combinations of digital and analog electronics.

B. Example Computer Program Implementations

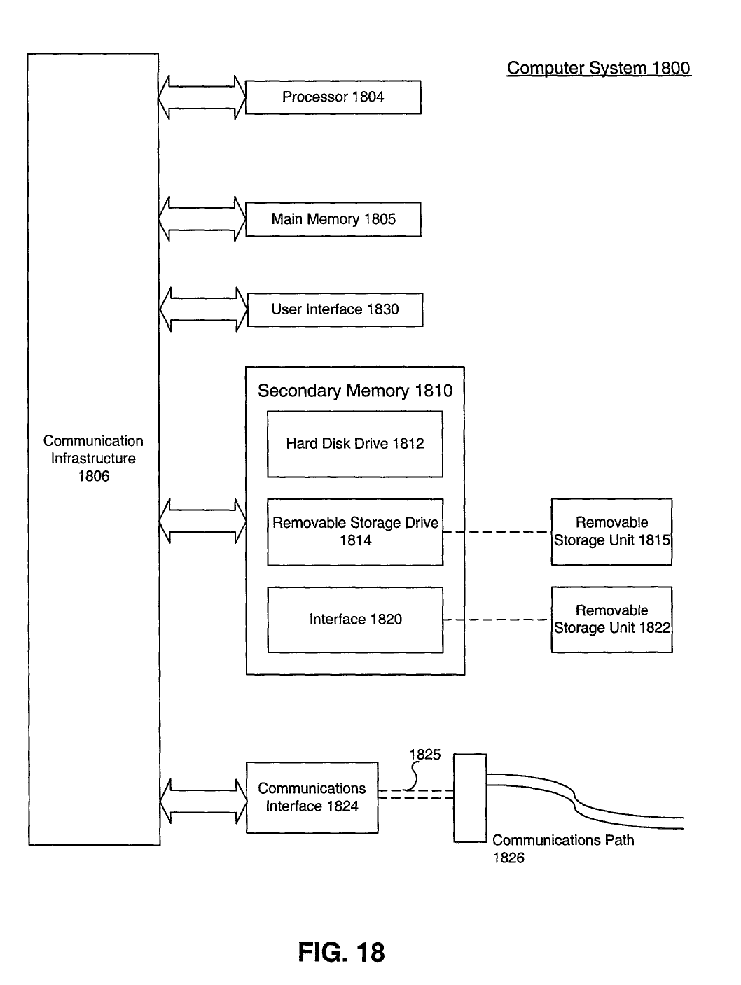

The present invention can also be implemented in computer-readable code, or software, that executes on a computer system. FIG. 18 illustrates an example computer system 1800, in which the present invention can be implemented as computer-readable code. Various embodiments of the invention are described in terms of this example computer system 1800. After reading this description, it will become apparent to a person skilled in the relevant art how to implement the invention using other computer systems and/or computer architectures.

In the present invention, all of the signal processing blocks of the present invention can execute on one or more distinct computer systems 1800, to implement the various methods of the present. The computer system 1800 includes one or more processors, such as processor 1804. Processor 1804 can be a special purpose or a general purpose digital signal processor. The processor 1804 is connected to a communication infrastructure 1806 (for example, a bus or network). Various software implementations are described in terms of this exemplary computer system. After reading this description, it will become apparent to a person skilled in the relevant art how to implement the invention using other computer systems and/or computer architectures.

Computer system 1800 also includes a main memory 1805, preferably random access memory (RAM), and may also include a secondary memory 1810. The secondary memory 1810 may include, for example, a hard disk drive 1812 and/or a removable storage drive 1814, representing a floppy disk drive, a magnetic tape drive, an optical disk drive, etc. The removable storage drive 1814 reads from and/or writes to a removable storage unit 1815 in a well known manner. Removable storage unit 1815, represents a floppy disk, magnetic tape, optical disk, etc. which is read by and written to by removable storage drive 1814. As will be appreciated, the removable storage unit 1815 includes a computer usable storage medium having stored therein computer software and/or data.

In alternative implementations, secondary memory 1810 may include other similar means for allowing computer programs or other instructions to be loaded into computer system 1800. Such means may include, for example, a removable storage unit 1822 and an interface 1820. Examples of such means may include a program cartridge and cartridge interface (such as that found in video game devices), a removable memory chip (such as an EPROM, or PROM) and associated socket, and other removable storage units 1822 and interfaces 1820 which allow software and data to be transferred from the removable storage unit 1822 to computer system 1800.

Computer system 1800 may also include a communications interface 1824. Communications interface 1824 allows software and data to be transferred between computer system 1800 and external devices. Examples of communications interface 1824 may include a modem, a network interface (such as an Ethernet card), a communications port, a PCMCIA slot and card, etc. Software and data transferred via communications interface 1824 are in the form of signals 1825 which may be electronic, electromagnetic, optical or other signals capable of being received by communications interface 1824. These signals 1825 are provided to communications interface 1824 via a communications path 1826. Communications path 1826 carries signals 1825 and may be implemented using wire or cable, fiber optics, a phone line, a cellular phone link, an RF link and other communications channels.

In this document, the terms “computer program medium” and “computer usable medium” are used to generally refer to media such as removable storage drive 1814, a hard disk installed in hard disk drive 1812, and signals 1825. These computer program products are means for providing software to computer system 1800.

Computer programs (also called computer control logic) are stored in main memory 1808 and/or secondary memory 1810. Computer programs may also be received via communications interface 1824. Such computer programs, when executed, enable the computer system 1800 to implement the present invention as discussed herein. In particular, the computer programs, when executed, enable the processor 1804 to implement the processes of the present invention. Accordingly, such computer programs represent controllers of the computer system 1800. By way of example, in the embodiments of the invention, the processes performed by the signal processing blocks of the present invention can be performed by computer control logic. Where the invention is implemented using software, the software may be stored in a computer program product and loaded into computer system 1800 using removable storage drive 1814, hard drive 1812 or communications interface 1824.

A user-interface 1830 is coupled to communication infrastructure 1806. User-interface 1830 can be any type of user-interface that provides control options to a user and receives inputs made by as user. User-interface 1830 can include a combination of software and hardware. For example, in the case of a graphical user-interface (GUI), user-interface 1830 can include both hardware (such as a display) and associated control logic for interfacing between the display and any applications using the GUI.

9. Conclusion

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof, as was described above in connection with FIG. 18, for example. Thus, the breadth and scope of the present invention should not be limited by any of the above-described exemplary embodiments, but should be defined only in accordance with the following claims and their equivalents.

What is claimed is:

1. A method for transforming limited source graphical data to coherent transformed data, comprising:
(a) identifying important elements in the limited source graphical data;
(b) identifying relationships between the identified important elements; and
(c) generating coherent transformed data representing the identified important elements and the identified relationships between elements.

2. The method of claim 1, wherein said generating step (c) comprises generating a hierarchical data structure.

3. The method of claim 2, further comprising:
storing the generated hierarchical data structure.

4. The method of claim 1, wherein the limited source graphical data comprises selected map files, and further comprising:
importing the selected map files prior to said identifying step (a).

5. The method of claim 4, further comprising:
enabling a user to configure a template that defines the coherent transformed data.

6. The method of claim 1, wherein the limited source graphical data comprises at least one map file having at least one of the following file formats: AutoCAD Drawing (dwg), Drawing Interchange Format (dxf), or PostScript (ps), and further comprising:
importing the at least one map file prior to said identifying step (a).

7. The method of claim 1, further comprising:
displaying a graphical representation of the coherent transformed data.

8. The method of claim 1, further comprising:
exporting the coherent transformed data to an external application.

9. The method of claim 1, further comprising:
generating a quality of result report based on the coherent transformed data.

10. The method of claim 1, further comprising:
making the coherent transformed data available to a user such that the coherent transformed data can be viewed or edited.

11. The method of claim 1, further comprising:
enabling a user to select a type of report to be generated based on the coherent transformed data.

12. The method of claim 1, wherein said limited source graphical data comprises map files, each map file representing graphical data that defines a respective portion of a cable network, and wherein said identifying step (b) comprises:
identifying device-link connections; and
identifying inter-map connections.

13. The method of claim 12, wherein said identifying step (b) further comprises:
identifying tap-pole connections;
identifying pole-house connections; and
identifying street-house connections.

14. The method of claim 13, wherein said generating step (c) includes correcting connections between elements in the coherent transformed data.

15. The method of claim 1, wherein said identifying step (b) further comprises:
connecting text descriptors with associated elements in the coherent transformed data.

16. The method of claim 15, wherein said text descriptors comprise tombstones and said connecting step connects the tombstones with associated elements in the coherent transformed data.

17. The method of claim 1, wherein said generating step (c) generates a hierarchical data structure, and further comprising:
storing the generated hierarchical data structure in a database.

18. A system for transforming limited source graphical data to coherent transformed data, comprising:
(a) means for identifying important elements in the limited source graphical data;
(b) means for identifying relationships between the identified important elements; and
(c) means for generating coherent transformed data representing the identified important elements and the identified relationships between elements.

19. The system of claim 18, wherein the limited source graphical data comprises selected map files, and further comprising:
means for importing the selected map files.

20. The system of claim 18, further comprising:
means for enabling a user to configure a template that defines the coherent transformed data.

21. The system of claim 18, further comprising:
means for exporting the coherent transformed data to an external application.

22. The system of claim 18, further comprising:
means for enabling a user to select a type of report to be generated based on the coherent transformed data.

23. The system of claim 18, wherein said limited source graphical data comprises map files, each map file representing graphical data that defines a respective portion of a cable network.

24. The system of claim 23, wherein said identifying means (b) comprises:
means for identifying device-link connections; and
means for identifying inter-map connections.

25. The system of claim 24, wherein said identifying means (b) further comprises:
means for identifying tap-pole connections;
means for identifying pole-house connections; and
means for identifying street-house connections.

26. The system of claim 23, wherein said generating means (c) includes means for correcting connections between elements in the coherent transformed data.

27. The system of claim 23, wherein said identifying means (b) further comprises:
means for connecting text descriptors with associated elements in the coherent transformed data.

28. A system, comprising:
a plurality of map files, each map file having limited source graphical data comprised of objects that define elements of a respective portion of a cable network, each map file having been generated to enable a respective map of the corresponding cable network portion including its respective elements to be visually output for printing or display; and
a map crawler tool, said map crawler tool comprising:
a user-interface; and
a transformation engine coupled to said user-interface,
wherein said user-interface receives input from a user and controls at least part of the operation of said transformation engine in response to the received input, and
wherein said transformation engine transforms the limited source graphical data in the plurality of map files to a hierarchical data structure representing elements in the cable network and relationships between the elements.

29. The system of claim 28, wherein said transformation engine identifies important elements from the objects present in the limited source graphical data, identifies relationships between the identified important elements, and builds said hierarchical data structure to represent the identified important elements and the identified relationships between the important elements.

30. The system of claim 28, wherein the elements of the cable network include devices and links, and wherein said transformation engine crawls through the map files, evaluates graphical data corresponding to devices and links in the respective maps, and identifies device-link connections between associated devices and links in each respective map.

31. The system of claim 30, wherein said transformation engine identifies said device-link connections between associated devices and links in each map based on a proximity rule.

32. The system of claim 30, wherein transformation engine further identifies inter-map connections between associated devices and links on different maps.

33. The system of claim 30, wherein said transformation engine generates and corrects a temporary hierarchical data structure until all connections are made and a final hierarchical data structure is obtained.

34. The system of claim 30, wherein said final hierarchical data structure comprises a hierarchical tree data structure.

35. The system of claim 34, wherein said hierarchical tree data structure includes the following tables of records: a tblEntityclass table having records for each class of elements, a tblEntitytype table having records for each specific type of element, a tblMap table having records for each map file, a tblEntity table having records for each important element present in the map files, and a tblConnection table having records for each connection between elements.

36. The system of claim 28, wherein the elements of the cable network include homes and poles, and the devices of the cable network include taps located on poles for routing cable traffic toward homes, and wherein said transformation engine identifies tap-pole connections between associated taps and poles.

37. The system of claim 36, wherein said transformation engine identifies said tap-pole connections between associated taps and poles based on a proximity rule.

38. The system of claim 36, wherein said transformation engine identifies pole-house connections between associated poles and houses.

39. The system of claim 38, wherein said transformation engine identifies said pole-house connections between associated poles and houses based on at least one of a proximity rule, graphical arrow data, graphical line data, and pole number information.

40. The system of claim 28, wherein the elements of the cable network include streets, and wherein said transformation engine determines the relative location of streets in map files, makes street connections for incomplete streets in a map and between maps, and associates street location and anme information based on associated graphical street name data and graphical street data.

41. The system of claim 40, wherein said transformation engine further builds house address information based on graphical house number data and associated graphical street information.

42. The system of claim 28, wherein the limited source graphical data comprises at least one map file having at least one of the following file formats: AutoCAD Drawing (dwg), Drawing Interchange Format (dxf), or PostScript (ps).

43. The system of claim 28, wherein said user-interface enables a user to select which map files are imported by said transformation engine.

44. The system of claim 28, wherein said user-interface enables a user to display a graphical representation of the hierarchical data structure.

45. The system of claim 28, wherein said user-interface presents a menu of connect control options that enables a user to select one or more types of connections made by said transformation engine.

46. The system of claim 28, wherein said user-interface presents a menu of report options that enables a user to select a type of report to be generated based on the hierarchical data structure.

47. A computer program product comprising computer usable media having computer readable program code means embodied in said media for causing a computer to transform limited source graphical data to coherent transformed data, said computer readable program code means comprising:
a first computer readable program code means for enabling a computer to identify important elements in the limited source graphical data;
a second computer readable program code means for enabling a computer to identify relationships between the identified important elements; and
a third computer readable program code means for enabling a computer to generate coherent transformed data representing the identified important elements and the identified relationships between elements.
